(19) United States
(12) Patent Application Publication
(10) Pub. No.: US 2004/0248536 A1
(43) Pub. Date: Dec. 9, 2004

(54) Receiving circuit having improved distortion characteristics

(75) Inventors: Hiroyuki Sato, Fukushima-ken (JP); Yasumasa Nishiyama, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/858,304

(22) Filed: Jun. 1, 2004

(30) Foreign Application Priority Data
Jun. 4, 2003 (JP) 2003-159068

(51) Int. Cl. H04H 1/00; H04B 1/06; H04B 7/00

(52) U.S. Cl. 455/232.1; 455/245.2; 455/241.1

(57) ABSTRACT

A receiving circuit includes a converter 1 of which gain is switched such that the gain is decreased through a plurality of stages in response to an increase in the intensity of the received signal, for converting the received signal into an intermediate frequency signal, and a base band processing circuit 5 for switching the gain of the converter 1. The gain of the converter 1 is switched to the lower level at the output level of the converter 1 corresponding to the minimum level of the received signal input into converter 1 at which an allowable error rate is secured in the base band processing circuit 5 at the maximum gain. When the converter 1 is set up to the maximum gain mode, the level of the intermediate frequency signal is lowered by attenuation means ATT provided in the converter 1.

### BACKGROUND OF THE INVENTION

1. Field of the Invention

The present invention relates to a receiving circuit used for a wireless communication terminal adopting a code division multiple access (CDMA) system.

2. Description of the Related Art

In a conventional receiving circuit shown in FIG. 3, an input signal can bypass a low noise amplifier (LNA) 30 by a switch 32. When the input signal bypasses the LNA 30, the LNA 30 is inactive and thus does not consume electric power. Therefore, the above structure in which the input signal bypasses the LNA 30 enables a wireless communication terminal to consume lower electric power.

The output from the LNA 30 or the switch 32 is supplied to an intermediate filter, such as a band-pass filter 34, and the output from the band-pass filter 34 is supplied to a variable gain mixer 46. The variable gain mixer 46 comprises an amplifier 38 and a mixer 40 as shown in FIG. 3. The amplifier 38 of the variable gain mixer 46 can also bypass by using a switch 42. When signals bypass the amplifier 38, the amplifier 38 is inactive, and thus power consumption in the wireless communication terminal does not increase.

In addition, when a wireless communication terminal is used in a CDMA mode and the intensity of a received signal is within the range of −94 dBm to −84 dBm, the switch 32 turns off, and the switch 42 turns on. Furthermore, the LNA 30 is set up so as to have a gain of 14 dB at a high intercept point (an intercept point of +6 dBm), and the mixer 46 is set up so as to have a gain of 5 dB. Therefore, the total gain thereof is 19 dB.

Further, when the intensity of a received signal is within the range of −84 dBm to −60 dBm, the switch 32 turns on, and the switch 42 turns off. Then, the LNA 30 is inactive. Therefore, the gain of the LNA 30 is set to −5 dB, and the gain of the mixer 46 is set to 15 dB. The total gain thereof is 10 dB.

Moreover, when the intensity of a received signal is more than −60 dB, both the switches 32 and 42 turn on. Therefore, the gain of the LNA 30 is set to −5 dB, and the gain of the mixer 46 is set to 5 dB. The total gain thereof is zero.

As described above, according to the conventional technique, in order to adjust balance between power consumption and linearity, the gain of the LNA 30 and the gain of the mixer 46 are controlled based on the intensity of a received signal (for example, see Patent Document 1).

[Patent Document 1]

PCT Japanese Translation Patent Publication No. 2002-522938(FIGS. 2 and 3)

In the aforementioned construction, the gain is switched at two points where the intensity of the received signal is −84 dBm and −60 dBm, and the maximum gain (19 dB) is obtained at a level less than the switching point of −84 dBm.

Meanwhile, in this type of wireless communication terminal, it is defined that the distortion characteristics (the linearity) of the wireless communication terminal should be measured at predetermined received signal intensity. However, when the point to be measured is set to be a little lower level (for example, −85 dBm) than the switching point, the distortion characteristics of the receiving circuit is measured at the maximum gain. Accordingly, the distortion characteristics thereof deteriorate. In addition, the distortion characteristics thereof deteriorate in actual practice.

### SUMMARY OF THE INVENTION

Accordingly, it is an object of the present invention to improve distortion characteristics by making the range of the received signal intensity that is used at the maximum gain narrow.

In order to achieve this object, the present invention provides a receiving circuit comprising: a converter whose gain is switched so as to be decreased through a plurality of stages in response to an increase in the intensity of a received signal, for converting the received signal into an intermediate frequency signal, and a base band processing circuit for switching the gain of the converter, wherein the gain of the converter is switched to a lower level at the output level of the converter corresponding to the minimum level of the received signal input into the converter at which an allowable error rate is secured in the base band processing circuit at the maximum gain, and wherein, when the converter is set to the maximum gain mode, the level of the intermediate frequency signal is lowered by attenuation means provided in the converter.

In addition, the gain of the converter is switched through three stages.

### BRIEF DESCRIPTION OF THE DRAWINGS

FIG. 1 is a circuit diagram illustrating the structure of a receiving circuit according to the present invention;

FIG. 2 is a view illustrating the relationship between a received signal level and an output level in the receiving circuit according to the present invention; and

FIG. 3 is a circuit diagram illustrating the structure of the conventional receiving circuit.

### DESCRIPTION OF THE PREFERRED EMBODIMENT

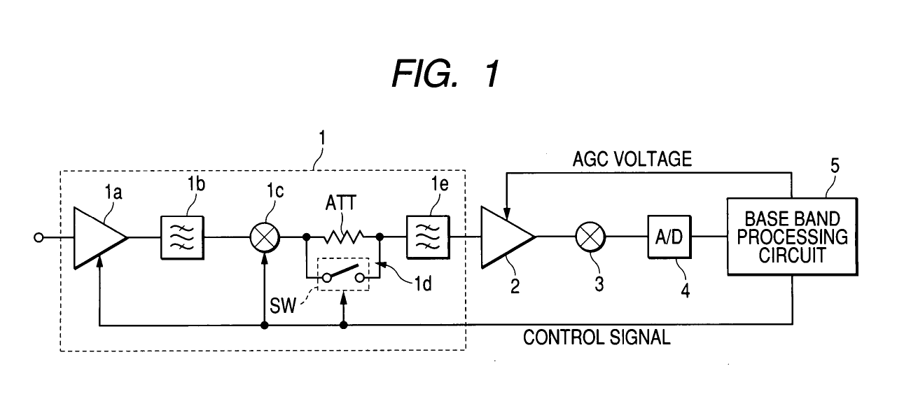

FIG. 1 shows a receiving circuit according to the present invention. A converter 1 comprises a low noise amplifier (LNA) la for amplifying a received signal, a mixer 1c for converting the received signal amplified by the LNA 1a into an intermediate frequency signal, a filter 1b interposed between the LNA 1a and the mixer 1c, attenuation switching means 1d for attenuating the intermediate frequency signal or for outputting the intermediate signal without attenuation, and a filter 1e provided at the next stage of the attenuation switching means 1d. The LNA 1a is formed as a variable gain amplifier, and the conversion gain of the mixer 1c is also varied. The attenuation switching means 1d comprises attenuation means ATT and switching means SW that bypasses the attenuation means ATT.

The intermediate frequency signal output from the filter 1e is supplied to a demodulator via an AGC amplifier 2, and is then demodulated by the demodulator. The demodulated signal is converted into a digital signal by an analog-to-digital (A/D) converter 4, and then the digital signal is processed by a base band processing circuit 5.

The base band processing circuit 5 outputs an AGC voltage for making the output of the AGC amplifier 2 a fixed level to control the gain of the AGC amplifier 2. In addition, the base band processing circuit 5 outputs a control signal so that, based on the intensity of the received signal input into the LNA 1a, it switches the gain (the total gain of the LNA 1a and the mixer 1c) of the converter 1 into three levels, such as A dB, B dB(=A−15 dB), and C dB(=B−7 dB=A−22 dB), thereby improving both reception sensitivity and disturbance characteristics.

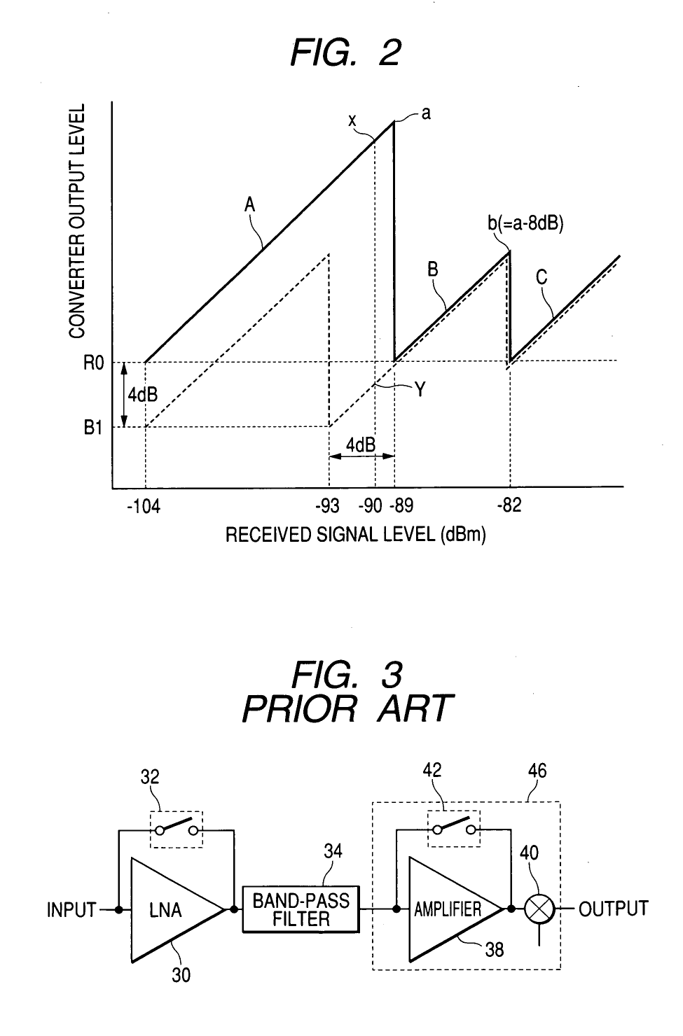

The switching of the gain of the converter 1 is performed, for example, based on the minimum level of the received signal input into the converter 1 at which an allowable error rate is secured in the base band processing circuit 5. For instance, when the minimum level of the received signal is −104 dBm and the output level from the converter 1 at that time is R0 as shown in FIG. 2, the gain of the converter 1 is switched to the maximum gain AdB (a high gain mode) within the range of the received signal level of −104 dBm to −89 dBm such that the output level from the converter 1 is more than R0. In addition, the gain of the converter 1 is switched to an intermediate gain BdB (an intermediate gain mode) when the received signal level is within the range of −89 dBm to −82 dBm, and is switched to the minimum gain CdB (a low gain mode) when the received signal level is more than −82 dBm.

Therefore, the output level corresponding to the received signal level input into the converter 1 is represented by a bold line in FIG. 2. In addition, the output level from the converter 1 has the maximum value of a at the received signal level of −89 dBm in the high gain mode, and has the value of b (=a−8 dB) at the received signal level of −82 dBm that is lower than the maximum value by 8 dB in the intermediate gain mode.

Accordingly, in the high gain mode, since the output level from the converter 1 increases (point X) at the received signal level of about 90 dBm, the output signal from the converter 1 is greatly distorted, and thus the output signal from the AGC amplifier 2 is distorted. Therefore, the characteristics of data measured at this received signal level deteriorate. According to the present invention, only in the high gain mode, the switching means SW turns off by the control signal output from the base band processing circuit 5, and the intermediate frequency signal is attenuated, for example, by 4 dBm. In this way, the output level is decreased by 4 dBm in the high gain mode, and the reference output level at the received signal level of −104 dBm becomes R1 (R0−4 dB).

That is, since when the gain of the converter 1 is switched, the output level is R1, the output level corresponding to the level of the received signal input into the converter 1 is represented by a bold dot line in FIG. 2. When the level of the received signal is more than −93 dBm, the converter 1 is switched to the intermediate gain mode, and the range of the received signal level that is used at the maximum gain is narrowed. Therefore, the output level corresponding to the input level of −90 dBm shifts to point Y.

As a result, when the received signal level is within the range of −104 dBm to −93 dBm, the output level from the converter 1 is lowered by 4 dB, and thus signal distortion in the AGC amplifier 2 is improved. In addition, when the received signal level is within the range of −93 dBm to −89 dBm, the output level from the converter 1 is decreased by 15 dB with a decrease in the gain of the converter 1. Therefore, signal distortion is improved in both the AGC amplifier 2 and the converter 1.

When the received signal level is less than −82 dBm, the converter 1 is switched to the low gain mode at the output level of R0. Therefore, the maximum output from the converter 1 is maintained at the low level in the intermediate gain mode, thereby improving distortion.

As described above, a receiving circuit according to the present invention comprises a converter of which gain is switched so as to be decreased through a plurality of stages in response to an increase in the intensity of a received signal, for converting the received signal into an intermediate frequency signal, and a base band processing circuit for switching the gain of the converter. The gain of the converter is switched to a lower level at the output level of the converter corresponding to the minimum level of the received signal at which an allowable error rate is secured in the base band processing circuit at the maximum gain. When the converter is set to the maximum gain mode, the level of the intermediate frequency signal is lowered by attenuation means provided in the converter. Therefore, the gain of the converter is switched to the lower level at the lower output level thereof. Accordingly, the range of the received signal level that is used at the maximum gain is narrowed, and the output level corresponding thereto is lowered, thereby improving distortion.

In addition, since the gain of the converter is switched through three stages, the maximum output level in the intermediate gain mode is maintained at a low level, thereby improving distortion.

1. A receiving circuit, comprising:
a converter whose gain is switched so as to be decreased through a plurality of stages in response to an increase in the intensity of a received signal, for converting the received signal into an intermediate frequency signal, and
a base band processing circuit for switching the gain of the converter,
wherein the gain of the converter is switched to a lower level at output level of the converter corresponding to a minimum level of the received signal input into the converter at which an allowable error rate is secured in the base band processing circuit at a maximum gain, and
wherein, when the converter is set up to a maximum gain mode, a level of the intermediate frequency signal is lowered by attenuation means provided in the converter.

2. The receiving circuit according to claim 1,
wherein the gain of the converter is switched through three stages.
